(19) United States
(12) Patent Application Publication
(10) Pub. No.: US 2010/0288739 A1
(43) Pub. Date: Nov. 18, 2010

(54) LASER PROCESSING DEVICE

(75) Inventors: Jae-Kwang Lee, Seongnam-si (KR); Sung Yi, Suwon-si (KR); Soon-Gyu Yim, Seongnam-si (KR)

Correspondence Address: MCDERMOTT WILL & EMERY LLP, 600 13TH STREET, N.W., WASHINGTON, DC, 20005-3096, US

(73) Assignee: SAMSUNG ELECTRO-MECHANICS CO., LTD.

(21) Appl. No.: 12/579,755

(22) Filed: Oct. 15, 2009

(30) Foreign Application Priority Data
May 18, 2009 (KR) 10-2009-0043076

(51) Int. Cl. B23K 26/38

(52) U.S. Cl. 219/121.67

(57) ABSTRACT

Disclosed is a laser processing device, which includes a processing beam source configured to irradiate a processing laser towards an object, a measuring beam source configured to irradiate a modulated measuring laser, an irradiator configured to align a path of the measuring laser with a path of the processing laser directed towards the object, a beam receiver configured to receive the measuring laser reflected from the object, an I/Q demodulator configured to calculate a phase difference between the measuring laser irradiated from the measuring beam source and the measuring laser received at the beam receiver, and a data processor configured to calculate a processed length of the object by using the phase difference. The invention can be used to measure the length of a laser-processed portion at the same time as the laser processing itself, so that the laser processing may be performed with improved precision.

### CROSS-REFERENCE TO RELATED APPLICATIONS

This application claims the benefit of Korean Patent Application No. 10-2009-0043076, filed with the Korean Intellectual Property Office on May 18, 2009, the disclosure of which is incorporated herein by reference in its entirety.

### BACKGROUND

1. Technical Field

The present invention relates to a laser processing device.

2. Description of the Related Art

Processing methods using laser are currently widely used not only in the build-up processes for printed circuit boards but also in the fields of semiconductor and metalworking. Laser processing is a non-contact form of processing that can be used for a variety of materials by modifying the wavelength and power of the laser. As such, laser processing has opened new possibilities for satisfying cost and performance requirements that could not be provided by the conventional etch processing.

While laser processing is used in almost every field of industry, it is especially useful in procedures for processing via holes in printed circuit boards. Laser processing can provide via holes that are deeper, compared to the diameter of the via hole, and can lower costs because the operations for applying photoresist used in etching processes can be omitted.

However, when using laser processing procedures to form via holes, the processing for each via hole may have to be completed within a short duration of time, and after the processing, the depth and diameter of the via holes may have to be examined using a microscope to check for defects.

Whether or not a via hole has been successfully processed depends on the quality of the via hole, with respect to the depth and the diameter. As such, measurements taken after the processing were an important indicator of whether or not a printed circuit board is defective. Here, the addition of a separate measuring procedure and the dependence of the total measuring time on the accuracy of the measurements made the measuring process a difficult task.

### SUMMARY

An aspect of the invention provides a laser processing device that allows real-time measurement of the length of the laser-processed portion.

Another aspect of the invention provides a laser processing device that includes: a processing beam source configured to irradiate a processing laser towards an object; a measuring beam source configured to irradiate a modulated measuring laser; an irradiator configured to align a path of the measuring laser with a path of the processing laser directed towards the object; a beam receiver configured to receive the measuring laser reflected from the object; an I/Q demodulator configured to calculate a phase difference between the measuring laser irradiated from the measuring beam source and the measuring laser received at the beam receiver; and a data processor configured to calculate a processed length of the object by using the phase difference.

Here, the irradiator can include: a first galvano mirror unit configured to alter a path of the processing laser; a second galvano mirror unit configured to alter a path of the measuring laser; and a dichroic mirror unit configured to transmit the processing laser reflected by the first galvano mirror unit but reflect the measuring laser reflected by the second galvano mirror unit. The beam receiver can include: a beam splitter configured to reflect the measuring laser reflected from the object; and a photodiode configured to receive the measuring laser reflected from the beam splitter.

The first galvano mirror unit can be rotated such that an irradiation position of the processing laser is altered, while the second galvano mirror unit can be rotated such that an irradiation position of the measuring laser coincides with the irradiation position of the processing laser.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 illustrates a laser processing device according to an embodiment of the invention.

### DETAILED DESCRIPTION

The laser processing method according to certain embodiments of the invention will be described below in more detail with reference to the accompanying drawings. Those components that are the same or are in correspondence are rendered the same reference numeral regardless of the FIGURE number, and redundant descriptions are omitted.

A laser processing device according to an embodiment of the invention may apply high-frequency modulation to a processing laser and a measuring laser and measure the measuring laser reflected off the processed surface using an I/Q (in-phase/quadrature) demodulator. In this way, the device may measure changes in the depth and diameter of a via hole in real time, in a shorter duration than the processing time.

An interferometer is a device for measuring the shape of a surface and various other physical properties using coherent laser beams. A commonly used method for observing interference is to use a splitter such that a portion of a beam is reflected while another portion of the beam is transmitted, and then overlay the two portions to observe the interference.

Examples of interferometers commonly used in measuring the shape of a surface include the Michelson interferometer and the Mach-Zehnder interferometer. The basic function of the interferometers includes measuring the minute phase difference between a reference beam and a signal beam or measuring changes in amplitude of the signal beam. Here, it may be needed to the keep the amplitude changes of the two beams constant, and to control the system against anomalies caused by the feedback of the reference beam. Because the dynamic range is bound by certain limits, such as the wavelength and detection rate, it can be difficult to detect changes in the phase and the intensity of the signal beam simultaneously.

The I/Q interferometer, which was developed to resolve the above drawbacks of interferometers, is capable of simultaneously measuring changes in phase and intensity of a signal beam independently. An I/Q interferometer in which the signal beam and the reference beam have the same frequency is referred to as a homodyne I/Q interferometer.

Since the homodyne I/Q interferometer does not have a limit on the range for measuring intensity changes in the signal beam, it is advantageously used in diagnosing the surface characteristics of samples, such as surfaces that have high dispersion, surfaces that are rough, and surfaces in which materials having different refractivity are mixed together, which exhibit large changes in reflectivity.

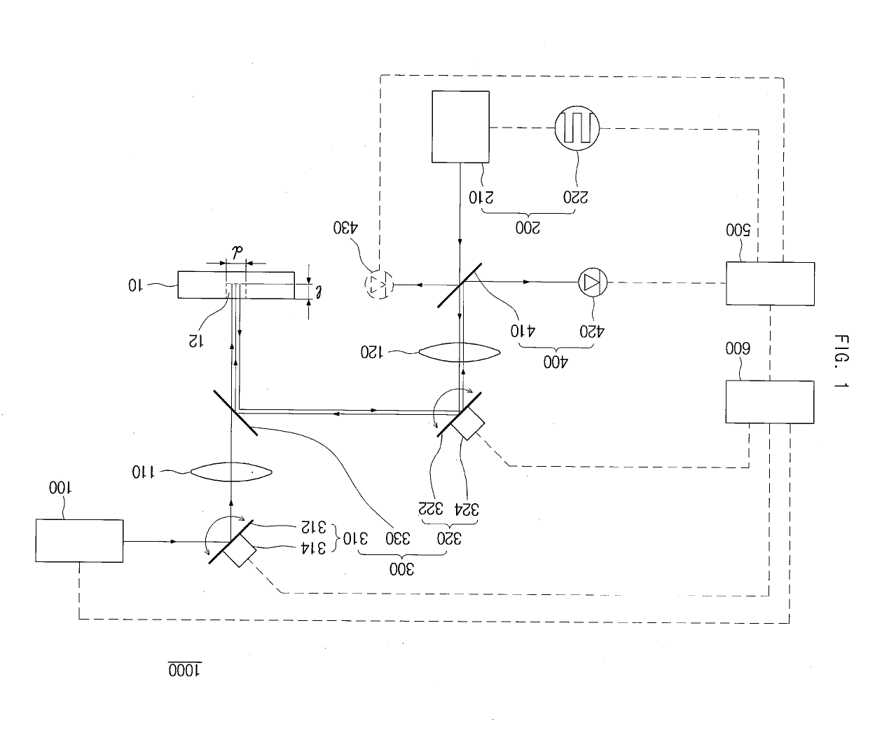

FIG. 1 illustrates a laser processing device according to an embodiment of the invention. As illustrated in FIG. 1, a laser processing device 1000 according to an embodiment of the invention may include a processing beam source 100, a measuring beam source 200, an irradiator 300, a beam receiver 400, an I/Q demodulator 500, and a data processor 600. By using a homodyne I/Q interferometer, it is possible to perform laser processing while simultaneously measuring the processed length, so that the precision of laser processing can be improved.

First, the processing beam source 100 may irradiate a processing laser towards the object being processed. The processing beam source 100 can be of various types, depending on the material of the object. For example, when processing a board 10 made of a polymer and ceramic material, as in this particular embodiment, a processing beam source 100 that is capable of firing a nanosecond laser or a femtosecond laser can be employed.

The processing laser irradiated from the processing beam source 100 may be refracted by a first galvano mirror unit 310 such that the path of the beam is altered, after which the beam may pass an objective lens 110 and a dichroic mirror unit 330 to be irradiated on the board 10. The processing laser irradiated on the board 10 may form a via hole 12 in a surface of the board 10.

The measuring beam source 200 may include a signal modulator 220 and a laser diode 210. A laser diode capable of high-frequency intensity modulation can be employed for the laser diode 210.

The wavelength of the measuring laser can be selected from within the range of visible rays, which can be recognized visually and which provide a superior performance to cost ratio. The intensity of the measuring laser can be determined in consideration of the modulation speed and the reflectivity of the surface of the board 10 being processed.

The signal modulator 220 can apply a voltage to the laser diode 210 to directly transfer the signals generated in a function generator by a direct modulation method of modulating intensity. Here, the modulation speed can be set according to measurement precision.

The irradiator 300 can align the path of the measuring laser with the path of the processing laser. The irradiator 300 can include a first galvano mirror unit 310, a second galvano mirror unit 320, and a dichroic mirror unit 330.

The first galvano mirror unit 310 may refract the processing laser irradiated from the processing beam source 100, such that the path of the processing laser is directed towards the board 10. The first galvano mirror unit 310 may include a galvano mirror 312 and a first driving unit 314 that rotates the galvano mirror 312 to alter the irradiation position of the processing laser.

The galvano mirror 312 of the first galvano mirror unit 310 can be rotatably coupled to the laser processing device 1000, and as the first driving unit 314 rotates the galvano mirror 312, the irradiation position of the processing laser can be altered. Thus, if the board 10 is to be processed in several places, the first galvano mirror unit 310 can alter the path of the processing laser.

The second galvano mirror unit 320 may alter the path of the measuring laser. The second galvano mirror unit 320 may include a galvano mirror 322 and a second driving unit 324 that rotates the galvano mirror 322 to alter the irradiation position of the measuring laser.

The galvano mirror 322 of the second galvano mirror unit 320 can be rotatably coupled to the laser processing device 1000, and as the second driving unit 324 rotates the galvano mirror 322, the irradiation position of the measuring laser can be altered.

The measuring laser irradiated from the measuring beam source 200 may pass through a beam splitter 410, pass through an objective lens, and then may be refracted by the second galvano mirror unit 320 towards the dichroic mirror unit 330.

The dichroic mirror unit 330 may transmit the processing laser towards the board 10 and reflect the measuring laser reflected by the second galvano mirror unit 320, so that the measuring laser may be directed towards the board 10.

Here, the second driving unit 324 can be synchronized with the first driving unit 314 so that the irradiation position of the measuring laser may coincide with the irradiation position of the processing laser. Thus, the measuring laser may track the irradiation position of the processing laser, making it possible to measure the length l of the via hole 12 being formed in the board 10 at the same time the board 10 is being processed.

The phase of the measuring laser reflected by the surface of the board 10 may be changed as the surface of the board 10 is processed by the processing laser. The measuring laser, having a changed phase, may pass through the dichroic mirror unit 330, second galvano mirror unit 320, objective lens 120, and beam splitter 410, to arrive at the beam receiver 400.

The beam receiver 400 can receive the measuring laser reflected from the board 10. The beam receiver 400 can include a photodiode 420 and a beam splitter 410.

The beam splitter 410 can transmit a portion of the measuring laser irradiated from the measuring beam source 200 and reflect the measuring laser reflected from the board 10 so that the measuring laser reflected from the board 10 may be reflected towards the photodiode 420.

The photodiode 420 can receive the measuring laser reflected from the beam splitter 410 and convert the measuring laser to an electrical signal. The photodiode 420 can have a faster reaction rate than the rate of signal modulation, and can achieve impedance matching with the I/Q demodulator 500.

The I/Q (in-phase/quadrature) demodulator 500 can calculate the phase difference between the measuring laser irradiated by the measuring beam source 200 and the measuring laser received at the beam receiver 400 and convert the result to an electrical signal.

With the measuring laser irradiated at the laser diode 210 from the signal modulator 220 set as a reference beam and the measuring laser reflected by the board 10 from the photodiode 420 set as a signal beam, the I/Q demodulator 500 may use the electrical signals of the reference beam and the signal beam to calculate the phase difference between the two.

The I/Q demodulator 500 can obtain the reference beam from the signal modulator 220 in the form of an electrical signal, as described above, or obtain the electrical signal of the measuring laser using a separate photodiode 430 for the portion of the measuring laser irradiated from the measuring beam source 200 that is reflected by the beam splitter 410.

Here, the photodiode 430 can convert the measuring laser into an electrical signal and transfer the signal to the I/Q demodulator 500, and the I/Q demodulator 500 can use this electrical signal as the reference beam. The photodiode 430 can have a faster reaction rate than the rate of signal modulation and can achieve impedance matching with the I/Q demodulator 500 for the electrical signal of the reference beam.

The I/Q demodulator 500 may calculate the phase difference regardless of the intensities of the reference beam and signal beam. Thus, the effects of the environment in which the surface of the board 10 is placed and the effects of surrounding noise can be minimized.

The phase difference between the reference beam and the signal beam, calculated by the I/Q demodulator 500, may be transferred as an electrical signal to the data processor 600. From this phase difference, the data processor 600 may calculate the depth l of the via hole 12 using a preset program.

In addition to calculating the depth of the via hole 12, the data processor 600 can serve as a control unit, sending electrical signals to each part of the laser processing device 1000 to control its operation.

The laser processing device can process a via hole using the processing laser, while at the same time measuring in real time the depth l of the via hole being processed, using the measuring laser. When the desired depth l of the via hole is obtained, the irradiating of the processing laser can be stopped, and any further measuring of the via hole depth l can be omitted.

Also, after the depth of the via hole 12 reaches a target value, the second galvano mirror unit 320 can be rotated such that the measuring laser is irradiated to either side of the via hole 12. Using the difference in height between the surface of the board 10 and the sides of the via hole 12, the laser processing device 1000 can also measure the diameter d of the via hole 12 or the area of the region processed by the laser.

As set forth above, certain aspects of the invention can be used to measure the length of a laser-processed portion at the same time as the laser processing itself so that the laser processing may be performed with improved precision.

While the spirit of the invention has been described in detail with reference to particular embodiments, the embodiments are for illustrative purposes only and do not limit the invention. It is to be appreciated that those skilled in the art can change or modify the embodiments without departing from the scope and spirit of the invention.

What is claimed is:

1. A laser processing device comprising:
a processing beam source configured to irradiate a processing laser towards an object to be processed;
a measuring beam source configured to irradiate a modulated measuring laser;
an irradiator configured to align a path of the measuring laser with a path of the processing laser directed towards the object;
a beam receiver configured to receive the measuring laser reflected from the object;
an I/Q demodulator configured to calculate a phase difference between the measuring laser irradiated from the measuring beam source and the measuring laser received at the beam receiver; and
a data processor configured to calculate a processed length of the object by using the phase difference.

2. The laser processing device of claim 1, wherein the irradiator comprises:
a first galvano mirror unit configured to alter a path of the processing laser;
a second galvano mirror unit configured to alter a path of the measuring laser; and
a dichroic mirror unit configured to transmit the processing laser reflected by the first galvano mirror unit and reflect the measuring laser reflected by the second galvano mirror unit.

3. The laser processing device of claim 2, wherein the beam receiver comprises:
a beam splitter configured to reflect the measuring laser reflected from the object; and
a photodiode configured to receive the measuring laser reflected from the beam splitter.

4. The laser processing device of claim 3, wherein the first galvano mirror unit is configured to rotate such that an irradiation position of the processing laser is altered.

5. The laser processing device of claim 4, wherein the second galvano mirror unit is configured to rotate such that an irradiation position of the measuring laser coincides with the irradiation position of the processing laser.
